(19) United States
(12) Patent Application Publication
(10) Pub. No.: US 2002/0135213 A1
(43) Pub. Date: Sep. 26, 2002

(54) Strut spring seat support

(75) Inventors: Patrick H. Fullenkamp, Bellbrook, OH (US); Sebastian Kaffanke, Centerville, OH (US); Piotr A. Kos, Centerville, OH (US); Miroslaw Pajak, Witanowice (PL)

Correspondence Address: DELPHI TECHNOLOGIES, INC., Legal Staff, Mail Code: 482-204-450, 1450 W. Long Lake, P.O. Box 5052, Troy, MI, 48098, US

(73) Assignee: DELPHI TECHNOLOGIES INC.

(21) Appl. No.: 09/813,176

(22) Filed: Mar. 20, 2001

(51) Int. Cl. B60N 2/00

(52) U.S. Cl. 297/311

(57) ABSTRACT

The present invention provides a strut spring seat support to support a coil spring and attachable to other vehicle suspension system components. The strut spring seat support comprises a spring seat bracket and a lower spring seat. In a preferred embodiment, the spring seat bracket is welded to the reservoir tube and the lower spring seat is positioned around the reservoir tube and projection welded to the spring seat bracket. The spring seat bracket can be attached to the stabilizer bar and the wheel assembly or, in an alternate embodiment, to the stabilizer bar alone

### TECHNICAL FIELD

The technical field of this disclosure is vehicle suspension systems, particularly, a strut spring seat support to support a coil spring and attachable to other vehicle suspension system components.

### BACKGROUND OF THE INVENTION

In present vehicle suspension systems, the lower end of a coil spring is supported by a spring seat. The spring seat is slipped over and welded to the reservoir tube, which is a major structural part of the automotive strut damper. The most common method of affixing the spring seat to a reservoir tube is using an arc (MAG) weld. Separate stab bar brackets for attaching the assembly to the stabilizer bar and knuckle attachments for attaching the assembly to the wheel assembly are also welded to the reservoir tube.

For example, the prior art conventional spring seat in a vehicle suspension assembly shown in FIGS. 1 and 2 provides a coil spring suspension for a vehicle wheel assembly 10. The strut module 20 can include a reservoir tube 22, a coil spring 24 supported by a conventional spring seat 26, a stab bar bracket 28, and a knuckle attachment 30. The conventional spring seat 26, stab bar bracket 28, and knuckle attachment 30 are welded to the reservoir tube 22. Welding the conventional spring seat 26 requires the work piece to be rotated, since the reservoir tube 22 is cylindrical. The strut module 20 attaches to the wheel assembly 10 at the knuckle attachment 30 and stab bar bracket 28 attaches to the stabilizer bar (not shown).

The spring seat assembly process is complicated by the part geometries and welding involved. Clearance is required between the spring seat and stab bar bracket to allow assembly. The spring seat hub must be directed downward to provide a welding surface. Welding spatters on the spring seat and reservoir tube surfaces may raise quality issues. The spring seat arc welding process is the longest procedure in the reservoir assembly process, requiring two spring seat welders in a cell in order to keep assembly time within reasonable limits. The parts must be rotated during arc welding to weld to the cylindrical reservoir tube. In addition, the arc welding process requires expensive welding consumables, such as gas mixture and welding wire.

The present spring seat design may also have problems from certain uses. High loads or defective welds may allow the spring seat to dislocate toward the bottom of the strut, causing potential tire damage. Loads are transmitted from the coil spring through welds to the reservoir tube, stressing the welds.

It would be desirable to have a strut spring seat support that would overcome the above disadvantages.

### SUMMARY OF THE INVENTION

One aspect of the present invention provides a strut spring seat support for a vehicle suspension assembly that combines components to simplify the assembly process.

Another aspect of the invention provides a strut spring seat support for a vehicle suspension assembly that allows use of projection welding methods during assembly.

Another aspect of the invention provides a strut spring seat support for a vehicle suspension assembly that has a longer lifetime due to improved load transfer to reduce the stress on welds.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 shows a prior art spring seat in a vehicle suspension assembly.

FIG. 2 shows a prior art conventional damper assembly.

FIG. 3 shows a perspective view of an embodiment of the strut spring seat support for a vehicle suspension assembly made in accordance with the present invention.

FIG. 4 shows a perspective view of an embodiment of the strut spring seat support for a vehicle suspension assembly made in accordance with the present invention.

FIGS. 5 and 6 show a perspective view of an alternate embodiment of the strut spring seat support for a vehicle suspension assembly made in accordance with the present invention.

### DESCRIPTION OF THE PREFERRED EMBODIMENTS

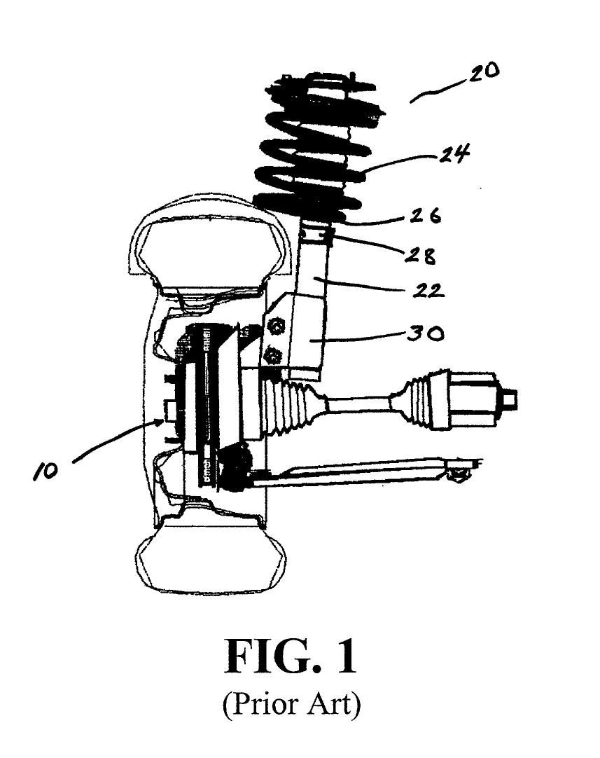

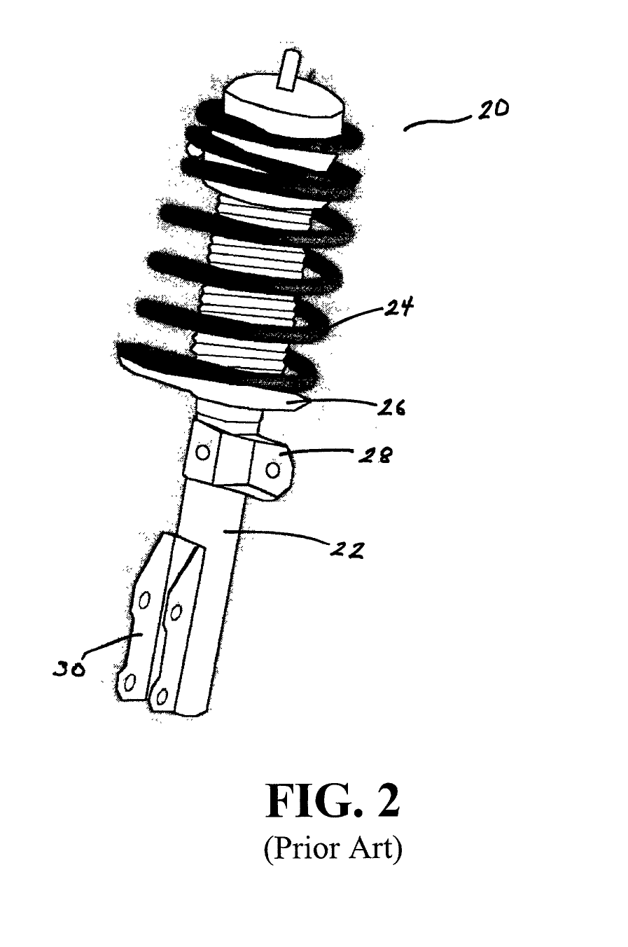

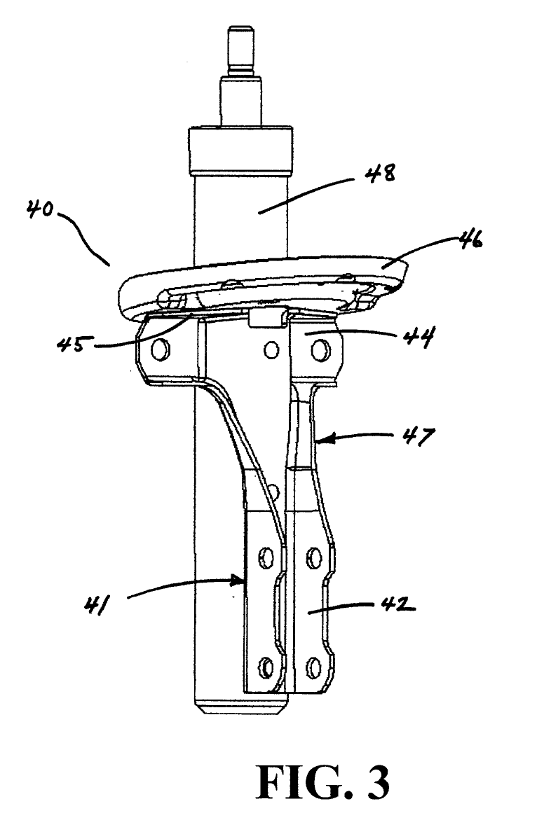

FIG. 3 illustrates one embodiment of a strut spring seat support for a vehicle suspension assembly. A spring seat assembly 40 can comprise a lower spring seat 46 and a spring seat bracket 47. The spring seat bracket 47 can further comprise a mounting bracket portion 42 and a stabilizer bar bracket portion 44. The mounting bracket portion 42 is adapted to attach to the wheel assembly of the vehicle suspension system and the stabilizer bar bracket portion 44 is adapted to attach to the stabilizer bar of the vehicle suspension system. (See FIG. 1).

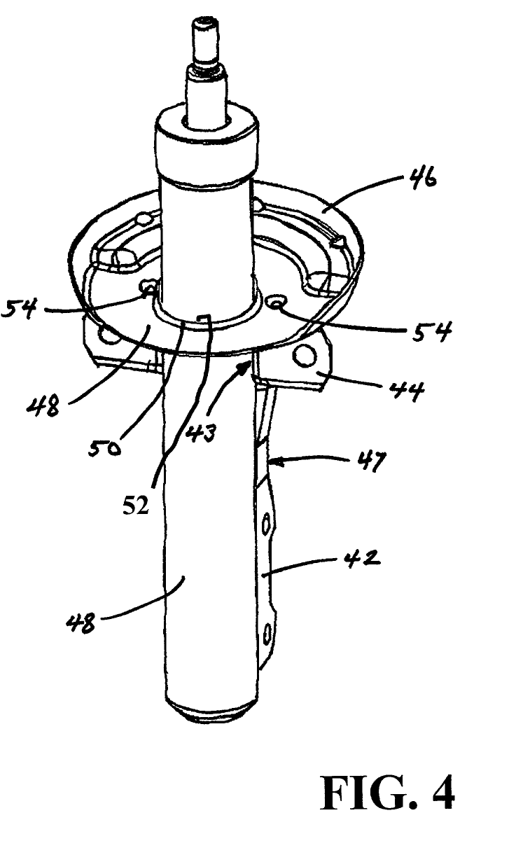

In one embodiment shown in FIG. 3, the mounting bracket portion 42 and the stabilizer bar bracket portion 44 can be formed from a single piece of metal. In an alternate embodiment, the mounting bracket portion 42 can be attached to the stabilizer bar bracket portion 44 by welding. The stabilizer bar bracket portion 44 can have a shelf 45 substantially perpendicular to the axis of the reservoir tube 48 for attaching and supporting the lower spring seat 46. The spring seat assembly 40 can be welded to the reservoir tube 48 using linear welds, where the mounting bracket portion 42 and the stabilizer bar bracket portion 44 contact the reservoir assembly along an axial line on the reservoir tube's surface at the mounting bracket edge 41 and the stabilizer bar bracket edge 43 (see FIG. 4), respectively.

Referring to FIG. 3., the spring seat assembly can be assembled by welding the spring seat bracket 47 to the reservoir tube. The lower spring seat 46 can be positioned on the reservoir tube through the reservoir tube opening 52 (See FIG. 4) with the lower spring seat 46 adjacent to the shelf 45. The lower spring seat 46 can then be welded to the shelf 45 of the spring seat bracket 47.

Referring to FIG. 4, where elements shared with those shown in FIG. 3 share like reference characters, provides further detail of the lower spring seat 46. The lower spring seat 46 can receive a coil spring (not shown). The lower spring seat 46 can comprise a circular portion 48 having a hub 50 forming an reservoir tube opening 52 disposed about the reservoir tube 48. The circular portion 48 can include projections 54 for welding. In an alternate embodiment, the projections may be provided on the shelf 45 of the spring seat bracket 47. The lower spring seat 46 can be attached to the stabilizer bar bracket portion 44 by projection welding. The circular portion 48 can extend substantially radially with respect to the axis of the reservoir tube 48. In one embodiment, the lower spring seat 46 can be stamped from a single piece of metal.

In projection welding, a high density current passes through a certain localized resistance path for a given length of time to produce the heat required to create a fusion between two parent metals. High forces can be applied to control the molten area and insure proper union. With projection welding, the character and location of the weld nugget can rely upon the work material itself. The electrode can serve to carry the required current and to apply the necessary force. The electrode, additionally, can provide a means for holding the work pieces during the complete welding cycle. In joining two works parts by projection welding, one of the parts can include projections. These projections can be embossments or protrusions in the parent metal and can be created, for example, through forming by stamping, coining, or machining. In one embodiment, the projections 54 can be formed in the stamping of the lower spring seat 46. In alternative embodiments, other welding methods, such as spot welding, can be used to connect the lower spring seat 46 to the stabilizer bar bracket portion 44.

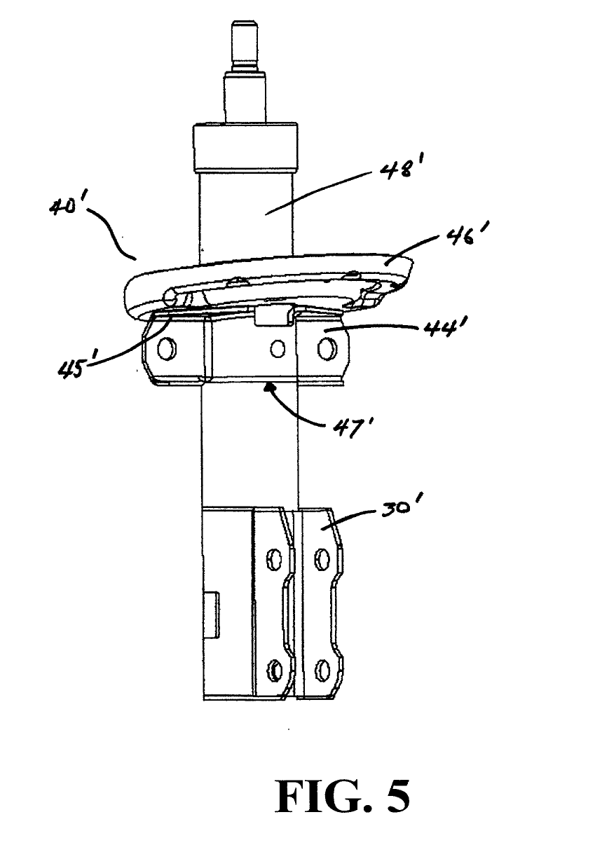

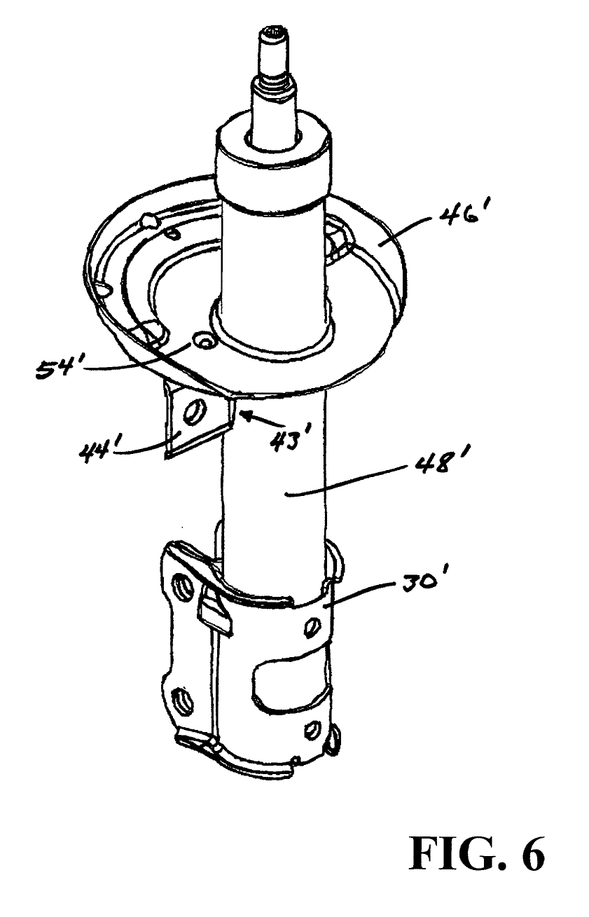

FIGS. 5 and 6, in which like elements share like reference characters, show an alternate embodiment of the strut spring seat support for a vehicle suspension assembly. The spring seat assembly 40′ provides an attachment to the stabilizer bar. The knuckle attachment can be separate from the spring seat assembly. The spring seat assembly 40′ can comprise a lower spring seat 46′ and a spring seat bracket 47′. The spring seat bracket 47′ can further comprise a stabilizer bar bracket portion 44′, which can be attached to the stabilizer bar of a vehicle suspension system. In one embodiment, the stabilizer bar bracket portion 44′ can be formed from a single piece of metal. The lower spring seat 46′ can be attached to the stabilizer bar bracket portion 44′ by welding. The stabilizer bar bracket portion 44′ can include an upper region 45′ substantially perpendicular to the axis of the reservoir tube 48′ for attaching and supporting the lower spring seat 46′. The spring seat assembly 40′ can be welded to the reservoir tube 48′ using linear welds, where the stabilizer bar bracket portion 44′ contacts the reservoir assembly at portion 43′ in an axial line on the reservoir tube's surface. Knuckle attachment 30′ can be, for example, welded or slip fit to the reservoir tube 48′. Projections 54′ can be provided on seat 46′ for attachment to the bracket portion 44′.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A strut spring seat support for a vehicle suspension assembly comprising:
a spring seat bracket having a shelf; and
a lower spring seat attached to the shelf.

2. The strut spring seat support of claim 1 wherein the spring seat bracket further comprises a mounting bracket portion and a stabilizer bar bracket portion.

3. The strut spring seat support of claim 1 wherein the spring seat bracket further comprises a stabilizer bar bracket portion.

4. The strut spring seat support of claim 1 wherein the spring seat bracket is formed from a single piece of metal.

5. The strut spring seat support of claim 1 wherein the shelf of spring seat bracket is attached to the lower spring seat by welding.

6. The strut spring seat support of claim 5 wherein the welding is projection welding.

7. The strut spring seat support of claim 5 wherein the welding is spot welding.

8. The strut spring seat support of claim 1 wherein the lower spring seat includes a projection.

9. The strut spring seat support of claim 1 wherein the shelf includes a projection.

10. The strut spring seat support of claim 1 wherein the lower spring seat further comprises a hub forming a reservoir tube opening, the hub disposed away from the spring seat bracket.

11. A strut spring seat support for attachment to a reservoir tube of a vehicle suspension assembly comprising:
a spring seat bracket attached to the reservoir tube, the spring seat bracket including a shelf; and
a lower spring seat disposed around the reservoir tube and attached to the shelf of the spring seat bracket.

12. The strut spring seat support of claim 11 wherein the spring seat bracket further comprises a mounting bracket portion and a stabilizer bar bracket portion, the mounting bracket portion including a mounting bracket edge, the stabilizer bar bracket portion including a stabilizer bar bracket edge, the spring seat bracket attached to the reservoir tube by welding along the mounting bracket edge and the stabilizer bar bracket edge.

13. The strut spring seat support of claim 12 wherein the welding along the mounting bracket edge and the stabilizer bar bracket edge is substantially linear.

14. The strut spring seat support of claim 11 wherein the spring seat bracket further comprises a stabilizer bar bracket portion, the stabilizer bar bracket portion including a stabilizer bar bracket edge, the spring seat bracket attached to the reservoir tube by welding along the stabilizer bar bracket edge.

15. The strut spring seat support of claim 14 wherein the welding along the stabilizer bar bracket edge is substantially linear.

16. A method for assembling a strut spring seat support for attachment to a reservoir tube of a vehicle suspension assembly comprising:
providing a spring seat bracket including a shelf;
providing a lower spring seat including a hub forming a reservoir tube opening;
welding the spring seat bracket to the reservoir tube;
positioning the lower spring seat on the reservoir tube through the reservoir tube opening, the lower spring seat adjacent to the shelf; and
welding the lower spring seat to the shelf of the spring seat bracket.

17. The method of claim 16 wherein the step of welding the lower spring seat to the shelf of the spring seat bracket further comprises projection welding the lower spring seat to the shelf of the spring seat bracket.

18. The method of claim 17 wherein the step of providing a lower spring seat further comprises providing a lower spring seat having a circular portion having projections.

19. The method of claim 17 further comprising providing a spring seat bracket having a shelf, the shelf including projections.

20. The method of claim 16 wherein the lower spring seat is spot welded to the shelf of the spring seat bracket.

21. The method of claim 16 further comprising providing a spring seat bracket including a stabilizer bar bracket portion, the stabilizer bar bracket portion including a stabilizer bar bracket edge, and linearly welding the stabilizer bar bracket edge of the spring seat bracket to the reservoir tube.

22. The method of claim 21 further comprising providing a spring seat bracket including a mounting bracket portion, the mounting bracket portion including a mounting bracket edge, and linearly welding the mounting bracket edge of the mounting bracket portion to the reservoir tube.
